(19) United States
(12) Patent Application Publication
(10) Pub. No.: US 2025/0170585 A1
(43) Pub. Date: May 29, 2025

(54) Electroseparator with at least an Approximately Point-Shaped Spray Electrode and Spray Ionisation Source

(71) Applicant: Oliver Schmitz, Mönchengladbach (DE)

(72) Inventor: Oliver Schmitz, Mönchengladbach (DE)

(21) Appl. No.: 18/834,303

(22) PCT Filed: Jan. 31, 2023
(86) PCT No.: PCT/DE2023/100073

§ 371 Date: Jul. 30, 2024

(30) Foreign Application Priority Data
Feb. 1, 2022 (DE) 10 2022 102 247.1

(51) Int. Cl. B03C 3/41; B03C 3/08; B03C 3/12; B03C 3/47; B03C 3/64

(52) U.S. Cl. CPC B03C 3/41; B03C 3/08; B03C 3/12; B03C 3/47; B03C 3/64; B03C 2201/10

(57) ABSTRACT

An electroseparator (10), through which an airflow to be purified of particles flows, includes an ionizer unit (26), which has one or more approximately point-shaped spray ionization sources (40) which consist of conductive fiber filament clusters, and a collector unit (12), arranged downstream of the ionizer unit, for particle separation. In order to reduce or eliminate wear that occurs in the medium to long term due to discharge-induced streaming effects, the filaments of the spray ionization sources are at least partially metal-coated, in particular nickel-coated, whereby streaming effects can be significantly reduced or even avoided entirely.

The present invention relates to an electrostatic precipitator or electro separator with approximately point-shaped spray electrodes. In particular, the invention relates to an electrostatic precipitator or electro separator with a reduction in discharge-related degeneration phenomena by modifying the spray electrodes.

Furthermore, the invention relates to a spray ionization source for use in such an electrostatic precipitator.

WO 2021/185418 A1 discloses a generic electrostatic precipitator optimized in terms of efficiency, size, power consumption and ozone emissions, which can be used as a mobile stand-alone device or as a component of air conditioning and ventilation systems, e.g. decentralized or centralized room ventilation systems. A wide range of industrial applications are also conceivable in the field of air purification and, in principle, also in the field of cleaning other gases, e.g. in the field of flue gas cleaning, or in the automotive sector (e.g. HVAC systems for vehicle interiors).

In recent years, it has been recognized what serious effects airborne particles with an aerodynamic diameter of 10 μm or less—so-called fine dust—or aerosols—especially bioaerosols can have on human health—think of the spread of the coronavirus through aerosols.

Since conventional filters, such as filter mats, are not very efficient in terms of their filtering performance, especially for smaller particles such as fine dust or aerosols, at least not if major pressure losses are to be avoided, high-voltage electrostatic precipitators or electrostatic filters (also known as electrical dust separation systems or electro separators) were proposed in the above-mentioned publication in order to separate the particles present in the air by means of electrical charges.

Compared to conventional filters based on adsorption and desorption effects and filter mats, these also have the advantage that many aerosol-bound viruses, especially the coronavirus, are immediately biologically inactivated at high electrical field strengths, so that they no longer pose a danger, even if the filter is cleaned.

For cleaning the air in rooms—e.g. for living or working rooms—two-stage electrostatic precipitators based on the so-called Penney principle are used in particular, although the present invention should not be limited in principle to discharges based on the Penney principle with positive ionizer potential. The use of negative ionizer potentials would also be conceivable in principle.

In an electrostatic precipitator, the particles to be separated are generally first electrically charged using a so-called ionizer. When a sufficiently high voltage is applied to the ionizer, a high field strength is created and, accordingly, a corona discharge is generated through local field ionization. This corona discharge initially generates positively (or negatively) ionized gas molecules in a spatially narrow zone around the ionizer (so-called corona plasma region), which move towards the negative electrodes and, on their further path outside the corona zone, collide with the (fine dust) particles or aerosols to be separated and also charge them.

The second stage of such an electrostatic precipitator consists of a collector unit arranged downstream of the ionizer unit in the flow direction usually consisting of a sequence of polarized plates or plates with alternating high voltages, through which the air to be cleaned flows with the particles previously charged by the ionizer unit. Due to the Coulomb forces, the positively charged particles drift to the plates that are negative or at least at a lower voltage potential (e.g. also at ground potential), the so-called collector plates where they adhere and can be removed by periodic cleaning or tapping. When negatively charged particles are separated, the potentials of the plates are of course reversed accordingly. The plates of the collector unit that are charged opposite to the collector plates are called driver plates; these, together with the collector plates opposite, provide the electric field for the electrostatic separation.

A disadvantage of electrostatic precipitators is the formation of ozone caused by the high-voltage-induced gas ionization processes, which can lead to anything from minor health impairments, such as mild eye irritation, to more serious health problems, such as headaches or respiratory problems, or to exceeding the permissible limit values for ozone, particularly when such electrostatic precipitators are used indoors.

The impact ionization processes also require a certain amount of electrical energy, so that in view of the fact that electrostatic precipitators are often used in continuous operation and the corresponding high-voltage power supplies are in principle subject to considerable losses, it is important to ensure that the ion generation is as efficient as possible in order to achieve the most energy-efficient operation possible.

The electrostatic precipitator known from WO 2021/185418 A1 mentioned above operates using approximately point-shaped spray ionization sources, preferably by means of conductive fiber bundles, in particular containing graphite-containing fiber filaments.

The use of such fiber bundles in the field of electrostatic precipitators is basically already known in the state of the art, cf. U.S. Pat. No. 10,384,517 B2.

Due to the tip effect of the thin filament ends, high local field strengths are achieved with small radii of curvature at the same time, which is favorable with regard to the ratio of deposition rate to ozone production rate, since small radii of curvature lead to high local field strengths and these in turn lead to a small corona plasma region, which, as mentioned, results in lower ozone production.

The known electrostatic precipitator uses a relatively large number of spray ionization sources arranged in a matrix, with each spray ionization source generating an electric field opposite associated hole edges of a perforated plate at an electrically opposite potential.

The ionization voltages used in the prior art, including U.S. Pat. No. 10,384,517 B2, are typically well below 8 kV, which may be sufficient for relatively small distances between the ionization electrode and the counter electrode.

However, in the context of WO 2021/185418 A1 mentioned at the beginning, an arrangement with larger distances between spray ionization sources and counter electrodes to the electrodes is proposed. In this context, it was recognized that such arrangements can perform significantly better than other known arrangements in terms of separation efficiency, power consumption and ozone generation due to the improved particle ionization cross sections.

However, it has also been found that the larger electrode distances make it necessary for optimum performance to operate the spray ionization sources with significantly higher voltages than is customary in the state of the art, ie with voltages ≥8 kV, typically even with more than 10 kV, or even with approx. 12 kV or more (eg ≥15 kV or ≥20 kV).

If such a high voltage ≥8 kV is applied to a very pointed, approximately point-shaped spray ionization electrode, the field strength increases sharply at the edges of the electrode.

In the context of the invention, under such conditions, a surprisingly rapid and severe wear of the fiber bundles occurred, which led to a decrease in separation efficiency, increased ozone production and undesirable noise generation.

This wear was surprising because the electrostatic precipitators in question are not exposed to any abrasive particles or particularly reactive gases when filtering the room air, or only to a small extent, and the flow speeds are so low that there was no real risk of mechanical wear on the spray ionization sources caused by the medium to be cleaned, i.e. the particle-containing room air. On the other hand, electrical arcing, which could damage the spray ionization sources due to sparks, is avoided wherever possible in such room air purifiers to minimize ozone, which is why this source of wear is also practically eliminated under intended operating conditions.

It has been found that the wear is primarily due to so-called streaming effects, whereby such streaming effects cause unwanted noise, lead to increased ozone production and electromagnetic interference and greatly accelerate ionizer wear.

The streaming effects mentioned are theoretically primarily attributed to the fact that high local field strengths lead to electrons and negative gas ions that cannot be transported away quickly enough and collide with the surface of the discharge electrode (anode) with high kinetic energy, tearing out material and thus creating microscopic “craters” with sharp edges. These sharp edges can in turn generate such high electric field strengths that the streamers mentioned above occur. It is also assumed that the reactive species emitted during a corona discharge, such as O⁺, O²⁺, NO⁺, also promote electrode erosion due to their reactivity.

These streaming effects are undesirable and there is a need to eliminate or at least minimize them in order to prevent premature wear of the spray ionization sources.

Although the spray ionization sources are basically designed to be wear parts and are replaceable, the desired service life time of such spray ionization sources, typically one year or more, may not be achieved due to the streaming effects without additional measures at the desired higher ionization voltages, because without specific measures the spray ionization sources can be worn out after just a few weeks of continuous operation.

An electrostatic precipitator of the type mentioned above using conductive fiber bundles as ionization sources with a typical operating voltage of approx. 10 kV with a downstream collector unit is also known from EP 3 932 563 A1.

US 2008/0 190 296 A1 discloses an industrial electrostatic precipitator, in particular for flue gas cleaning, in which parallel ionizer electrode and collector plates are provided, whereby these ionizer electrode plates can be subjected to high voltages of 20 kV to 35 kV. The ionizer electrode plates can be made of a composite material with conductive fibers protruding from the surface, whereby the protruding fiber ends can be coated with a metal to prevent damage due to electrical arcing or due to wear caused by the abrasive flue gas medium.

The object of the present invention is to provide measures by means of which undesirable streaming effects can be minimized or eliminated even at ionization voltages of more than approximately 8 kV.

The above-mentioned object is achieved by means of an electrostatic precipitator or a spray ionization source for such an electrostatic precipitator according to the features of the independent patent claims.

Advantageous embodiments of the invention are explained in the dependent patent claims.

To achieve the above-mentioned object, in an electrostatic precipitator through which an air flow to be cleaned of particles, in particular a room air flow to be cleaned, flows, with an ionizer unit which has one or more ionizer rows arranged within the air flow, each ionizer row having at least one approximately point-shaped spray ionization source to which an electrical ionizer potential is applied, at least one of the spray ionization sources being essentially formed from a bundle of electrically conductive fibers, and with a collector unit for particle separation arranged downstream of the ionizer unit, with a plurality of essentially parallel, electrically conductive collector and driver plates through which the air flow flows and which are alternately subjected to electrical collector or opposite driver potentials, it is proposed that the electrically conductive fibers of the spray ionization source be at least partially provided with a metallic coating.

These modification measures on the spray ionization sources themselves can also be supported by so-called field-modifying measures, by which the maximum field strengths in the immediate vicinity of the spray ionization source are reduced and/or by which the ion removal from the corona zone is improved in order to further reduce or eliminate the streaming effects overall.

The (at least partial) metallic coating is intended to achieve a significant reduction in wear and an extension of service life of the spray ionization sources with regard to streaming effects, which can mean that due to the at least partial metallic coating of the electrically conductive fibers, a typical service life of a spray ionization source in an electrostatic precipitator operated with relatively high ionization voltages of ≥8 kV is achieved of at least one year (preferably at least approx. 3 years), whereas the spray ionization source without the metallic coating in such an electrostatic precipitator would be worn out after just a few weeks of continuous operation due to streaming effects.

Without the streaming effects mentioned above, the wear of the fiber bundles—regardless of a metallic coating—would be minimal, since the mechanical stress on the fibers, e.g. due to abrasive particles, is low when used in such electrostatic precipitators and arcing generally does not occur.

Preferably, the coating consists essentially of nickel or at least of a nickel alloy, preferably with more than 50% nickel content. For example, a nickel/chromium alloy can be used as the nickel alloy, with nickel as the main component.

Chromium can be present in such a nickel/chromium alloy either in a relatively high proportion (between 10% and less than 50%) or in a proportion lower than 10%. Such a chromium addition tends to increase oxidation resistance.

As is known in metallurgy, a nickel/chromium alloy can also contain other components such as aluminum, silicon, manganese, cobalt, hafnium, rhenium or other rare earth metals such as yttrium can be added in small amounts to improve the strength, oxidation and corrosion properties, with nickel and—to a lesser extent—chromium remaining the main components. The term “nickel/chromium alloy” is not intended to exclude other alloy additions, although pure nickel/chromium alloys can also be used.

However, it is also conceivable that other conductive metals or metal alloys are used for such a coating, e.g. precious metals such as gold, silver, platinum, iridium, palladium, or semi-precious metals such as copper or subgroup elements such as chromium, molybdenum or tungsten or alloys of these elements or other elements.

However, the coating preferably consists of pure nickel, which is preferably applied to the fibers by means of chemical vapor deposition.

The electrically conductive fibers are preferably carbon or graphite filaments or, if necessary, fibers spun from such filaments, whereby bundles or tufts of single filaments (as opposed to multifilament fibers) are preferably used.

Carbon or graphite filaments—these terms should be understood as synonyms here—are fibers made from carbon-containing starting materials that are converted into graphite-like carbon in fiber form via chemical processes, whereby the so-called anisotropic types preferred here are known to achieve very favorable mechanical properties and at the same time very good conductivity.

In a preferred embodiment, the bundles of electrically conductive fibers of the spray ionization source also have one or more of the following properties:
the electrically conductive fibers of the fiber bundle are formed as graphite or carbon filaments or as fibers spun from such filaments; and/or
the electrically conductive fibres are synthetic fibres made of a conductive polymer or of a polymer with conductivity-enhancing additives; and/or
the individual fibres have a fibre thickness of less than 20 μm each; and/or
the fibre bundle consists of 16 individual fibres or more, preferably up to 96,000 fibres, most preferably between 3,000 and 48,000 fibres; and/or
the free fibre length between the exit from a holder holding the bundle together and the front end of the fibres is, for the majority of the fibres of the fibre bundle, between 2 mm and 25 mm, preferably between 5 mm and 12 mm.

This means that in addition to or instead of pure carbon filaments or -fibers, other conductive fibers can also be used, e.g. electrically so-called self-conducting polymers or, for example, graphite-reinforced plastics (carbon fiber reinforced plastics, CFRP).

In general, the fibers of the fiber bundles are preferably quite filigree due to a preferred diameter of less than 20 μm and the relatively large free fiber length of several millimeters compared to the diameter.

The term “fiber bundle” or “fiber tuft” further implies that the individual fibers of the bundle—starting from a common holder—diverge in a tuft-like manner with increasing distance from the holder, so that the fiber ends do not form a continuous surface.

The intrinsic conductivity of the fibers does not necessarily have to be very high—although it is actually quite high in the case of the carbon fibers that are preferred—because the metallic coating can also contribute to the conductivity of the fibers.

Particularly preferably, the fibers of the fiber bundle have a diameter of 5 μm to 20 μm, preferably between 5 μm and 10 μm.

The (average) metal coating thickness can preferably be between 0.05 μm and 1.0 μm, preferably between 0.2 μm and 0.5 μm.

Particularly preferred, the fibers of the fiber bundle are metallically coated substantially along the fiber circumferential sides, at least in the spatial proximity of the free front ends, whereby the front sides of the free front ends are preferably uncoated, so that the coating can be carried out before the fibers are composed.

Preferably, at least one spray ionization source or preferably all of the spray ionization sources are subjected to a relatively high ionizer potential of at least 8 kV each, preferably more than 10 kV, and most preferably more than 12 kV.

In one embodiment of the invention, the ionization current per spray ionization source can be limited to less than 100 μA.

Furthermore, the spatial distance of each spray ionization source from the corresponding counter electrode of the collector unit or from another electrode at the most opposite potential (e.g. the conductive outer walls of the flow channel at ground potential) is preferably at least approx. 75 mm, whereby this value is to be understood as an example and depends on many design parameters.

Furthermore, within the scope of the invention, a spray ionization source consisting of a bundle of electrically conductive fibers with a metallic coating as described above is proposed, which is accordingly intended—if necessary as a replaceable part—for use in the electrostatic precipitator described above.

In addition to the bundle of coated conductive fibers, this spray ionization source can of course also have other elements, such as an electrically conductive holder for holding the fiber bundle or fiber tuft and, if necessary, an insulated electrical supply line.

The invention is explained in more detail below with reference to the embodiments shown in the drawings.

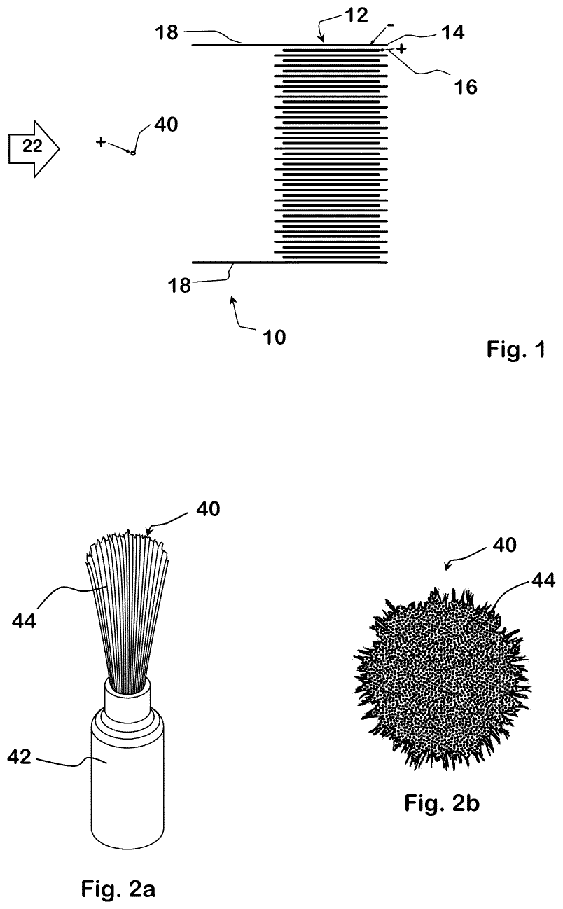

FIG. 1 is a schematic view of a two-stage electrostatic precipitator using a spray ionization source;

FIGS. 2a,b show a schematic isometric view and a plan view of an example of a spray ionization source according to the invention;

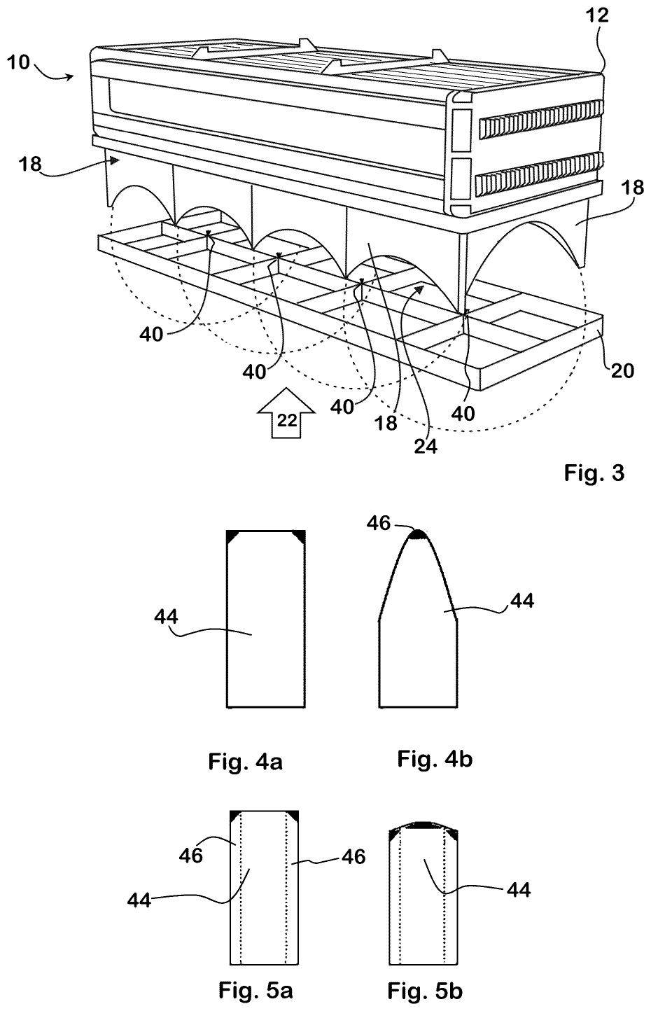

FIG. 3 is a schematic perspective view of an electrostatic precipitator with multiple spray ionization sources;

FIGS. 4a,b show schematic representations of the wear behaviour (before-and after) of an uncoated carbon filament;

FIGS. 5a,b show schematic representations of the wear behaviour (before-and after) of a nickel-coated carbon filament;

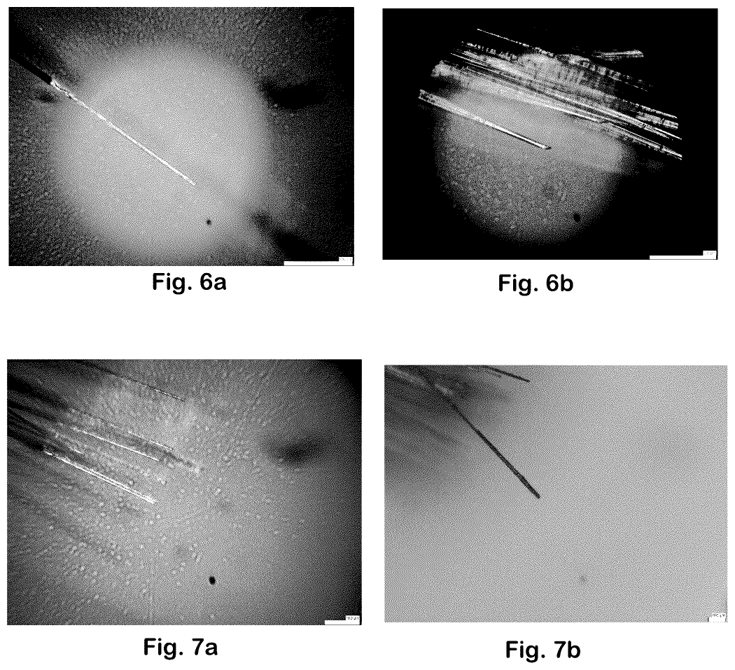

FIGS. 6a,b show microscopic images of the wear behaviour (before-and after) of an uncoated carbon filament bundle; and

FIGS. 7a,b show microscopic images of the wear behavior (before-and after) of a nickel-coated carbon filament bundle.

The two-stage electrostatic precipitator following the Penney principle shown schematically in FIG. 1 goes back to the WO 2021/185418 A1 mentioned at the beginning, whereby this document is to be incorporated into the present application by reference with regard to further details of the corresponding electrostatic precipitator.

The electrostatic filter 10 according to FIG. 1 is located in an air duct not shown in FIG. 1—this can be, for example, an air duct in a separate air cleaner or, for example, a duct in a central or decentralized living space ventilation system, or a duct in an HVAC system of a motor vehicle. In the air duct, a forced flow in the direction of arrow 22 is generated by suitable means, in particular by one or more fans.

The core element of the electrostatic precipitator is the approximately point-shaped spray electrode 40, which in the example is subjected to a positive high-voltage potential (the high-voltage source and supply lines are not shown), which is the end of a bundle of thin conductive fibers, usually graphite filaments, which are also referred to as carbon fibers.

This spray electrode 40 is the main component of an ionizer unit, which in other embodiments may also have several spray electrodes as well as mechanical support and power supply structures.

The term “approximately point-like” is intended to express that the spray ionization emanates from a tip of a fiber-like element with a very small radius of curvature (compared to the other dimensions of the device), so that due to the electrical tip effect, the corresponding electric field and the ionization effect can be regarded as approximately primarily emanating from a point, although the point here naturally represents a mathematical idealization.

In the example of FIG. 1, only a single spray ionization source 40 is shown. However, several spray ionization sources, e.g. arranged in a matrix, can be provided in different configurations, as it is also explained in more detail in WO 2021/185418 A1.

The spray ionization source 40 generates—as already described in the introduction—a corona discharge with the formation of a local corona zone, which leads to an ionization of the air molecules and, through accumulation and interaction processes in a wider volume area, to the positive (or possibly also negative) charging of the particles flowing through and to be separated.

These are then deposited in a collector unit 12, which is at a high absolute voltage potential (positive or negative) compared to the ionization source, for which an electrostatic field is generated between positively or negatively charged driver electrode plates 16 and collector electrode plates 14, so that the positively ionized particles are deposited by electrostatic attraction on the collector plates with a lower voltage potential or ground potential. The absolute driver potential is generally selected to be lower than the ionizer potential in order to avoid arcing between the preferably very closely spaced plate pairs.

In the context of the invention described in WO 2021/185418 A1, negatively charged additional electrodes are also proposed to improve the separation performance; among other things, so-called edge counter electrodes 18, see also the illustration in FIG. 3. These additional electrodes can advantageously be used in conjunction with the present invention; however, this expressly does not have to be the case, i.e. the present invention is not limited to use with the electrostatic precipitator described in WO 2021/185418 A1 with additional collector electrodes.

Rather, the present invention can generally be used in electrostatic precipitators with approximately point-shaped spray ionizers, independently of the specific design of the collector unit 12 as well as independently of the presence of further electrodes and also independently of the type and arrangement of fans.

FIG. 3 shows a schematic of an embodiment of an electrostatic precipitator with several, in the example four, evenly spaced spray ionization sources 40, each of which is designed as a fiber bundle of conductive fibers, and which are arranged on a support structure 20, in which the high-voltage supply lines are also integrated, in a matrix-like manner approximately centrally with respect to four main flow sections, spaced from the collector unit 12, which has edge counter electrodes 18 surrounding the main flow sections, each with arc-shaped recesses 24. The spray ionization sources 40 are preferably subjected to relatively high voltages of generally significantly more than 10 kV (e.g. 12 kV, 14 kV or more) and are geometrically spaced relatively far from the respective elements at counter potential, so that high ionization performance can be achieved with minimal ozone generation while avoiding sparking, which, however, can lead to the increased wear mentioned at the beginning due to streaming effects, which is why the metal-coated fiber bundles according to the invention can be used with advantage in such separators (but not only there). For further details of the electrostatic precipitator according to FIG. 3, reference is made to WO 2021/185418 A1.

FIGS. 2a, b show schematically a spray ionization source 40 with a graphite fiber filament tuft or fiber bundle in an isometric view and in a plan view. The individual fibers are designated with 44, whereby the number and diameter of the filaments are not to scale.

The spray ionization source 40 is held by a holder or a socket 42, which is also designed to be electrically conductive and applies the ionizer potential to the individual fibers 44 via a high-voltage source (not shown here).

At relatively high ionizer potentials starting at approx. 8 kV, but preferably approx. 10 KV or approx. 12 kV or more, the streaming or streamer effects mentioned above occur over time when using uncoated graphite filaments, so that the service life of the spray ionization sources is unsatisfactory.

Based on the microscope images in FIGS. 6a and 6b, which show graphite filaments in their original state (FIG. 6a) compared to fibers affected by streaming effects (FIG. 6b), it is clear-especially in the lowest fiber in FIG. 6b—that the originally “round” fiber tip is now asymmetrical. Such a “pointed” fiber end no longer has the necessary mechanical stability and tends to cause streaming effects, especially since the wear intensity increases due to the even stronger electrical tip effect.

Considering this, a metallic coating of the fibers, preferably with a nickel layer or with a nickel alloy layer, is proposed within the scope of the invention, whereby in the example of the microscopic representations (according to FIGS. 7a and 7b) a pure nickel coating was used.

The corresponding before-and-after comparison is shown in FIGS. 7a and 7b, whereby the corresponding fibers in FIGS. 6a,b and 7a,b were exposed to comparable parameters (discharge geometry, ionization voltage, service life, etc.). The coated fibers visible in FIG. 7b still have a “round” tip shape, even after a longer service life, so that self-reinforcing streaming effects do not occur.

The inventors suspect that the better stability is largely due to the different wear behavior schematically illustrated in FIGS. 5a,b and 6a,b:

In the case of the uncoated fiber end 44 shown in FIGS. 4a (before) and 4b (after), wear due to the discharge processes begins at the upper edge marked in black and leads to a “tapering” of the geometry, which is symmetrical here, but in practice, as can be seen from FIG. 6b, can also be asymmetrical and leads to the streamer effects mentioned.

In the case of a nickel-coated fiber end 44 according to FIGS. 5a (before) and 5b (after)—the nickel coating is not shown to scale in dashed lines and is designated as 46—the front edge is protected from wear, so that overall there is more even wear without “tapering”, as indicated in FIG. 5b. Considering this, a metallic coating of the front side of the fiber is not absolutely necessary (this would also be quite complex in terms of production technology, because the filaments would then have to be coated in ready-made form), because the edge protection is essential for achieving the inventive effect.

Furthermore, it is conceivable that the wear-protective effect of a nickel coating (or a coating with a nickel alloy) is related to the formation of a protective oxide layer on the metal (“passivation”).

According to current theories, the formation of a metal oxide takes place either at the inner (facing the metal) or at the outer (facing the ambient air) interface of the oxide layer. If the mobility of the metal cations in the metal oxide is much greater than the mobility of the oxygen anions—which is the case for nickel at room temperature conditions and natural oxygen partial pressures—then according to the theories, the oxidation takes place essentially at the outer interface.

Under living and indoor conditions, a stable, passive and outward-growing oxide layer forms on a nickel-coated electrode surface.

It is believed that this provides a dielectric barrier (insulation) for the current and protection against further oxidation.

Two main mechanisms are assumed for the erosion of metal-coated fibers, as used in the present electrostatic precipitators:

On the one hand, erosion through so-called ion-and electron-induced sputtering, i.e. collision of electrons or ions with the surface, whereby this process shows a clear temperature dependence due to the required activation energies.

On the other hand, there are erosion effects caused by reactive species emitted during a corona discharge, such as O⁺, O²⁺ or NO⁺. The latter effect shows only a slight temperature dependence and tends to depend more on the generation rate of the reactive species, i.e. primarily on the ionization current.

Therefore, both effects can fundamentally be differentiated experimentally by varying temperature and ionization current.

Such experiments suggest that nickel passivation is particularly effective in mitigating or preventing the erosion effects caused by the reactive species emitted by a corona discharge.

Furthermore, tests have suggested that in the case of materials such as nickel that form oxide layers, those alloys—for example nickel/chromium alloys—have a particularly high level of wear resistance whose oxide layers grow slowly in the initial stage, passivate quickly and which form a good bond with the metal surface.

In contrast to nickel, noble metals—such as platinum—form only very thin oxide layers or none at all at technically relevant temperatures and are therefore possibly less effective within the scope of the invention than non-noble metals or their alloys, which form a passivating oxide layer, in particular a passivating oxide layer that grows outwards. Notwithstanding this, nobler metals or their alloys can also be used within the scope of the invention.

An example of such a coated carbon fiber filament that can be used for the purposes of the invention would be a carbon fiber with a filament diameter of approximately 7 μm, which is coated on the outer surfaces, but not on the end faces, with a nickel coating with a thickness of approximately 0.25 μm. This coating can be carried out in particular by means of chemical vapor deposition.

1. Electrostatic precipitator (10) through which an air stream to be cleaned of particles, in particular a room air stream to be cleaned, flows, comprising:
i) an ionizer unit (26) which has one or more ionizer rows arranged within the air flow, each ionizer row having at least one approximately point-shaped spray ionization source (40) subjected to an electrical ionizer potential, at least one of the spray ionization sources (40) being formed essentially from a bundle of electrically conductive fibers, and with
ii) a collector unit (12) arranged downstream of the ionizer unit for particle separation, with a plurality of substantially parallel arranged, electrically conductive collector and driver plates (14, 16) through which the air flow flows, which are alternately subjected to electrical collector and opposite driver potentials,
wherein the electrically conductive fibers of the spray ionization source (40) are at least partially provided with a metallic coating.

2. Electrostatic precipitator according to claim 1, wherein due to the at least partial metallic coating of the electrically conductive fibers, a typical service life of the spray ionization source in an electrostatic precipitator operated with relatively high ionization voltages of ≥8 kV of at least one year is achieved, whereas the spray ionization source without the metallic coating would be worn out after just a few weeks of continuous operation due to streaming effects in such an electrostatic precipitator.

3. Electrostatic precipitator according to claim 1, wherein the coating consists essentially of nickel or a nickel alloy, in particular a nickel-chromium alloy, preferably a nickel alloy with more than 50% nickel content.

4. Electrostatic precipitator according to claim 3, wherein the coating consists of pure nickel, which is preferably applied to the fibres by chemical vapor deposition.

5. Electrostatic precipitator according to claim 1, wherein the electrically conductive fibers are carbon or graphite filaments or are formed as fibers spun from such filaments.

6. Electrostatic precipitator according to claim 1, wherein the bundle of electrically conductive fibers of the spray ionization source has one or more of the following properties:
the electrically conductive fibers of the fiber bundle are formed as graphite or carbon filaments or as fibers spun from such filaments; and/or
the electrically conductive fibres are synthetic fibres made of a conductive polymer or of a polymer with conductivity-enhancing additives; and/or
the individual fibres have a fibre thickness of less than 20 μm each; and/or
the fibre bundle consists of 16 individual fibres or more, preferably up to 96,000 fibres, most preferably between 3,000 and 48,000 fibres; and/or
the free fiber length between the exit from a holder holding the bundle together and the front end of the fibers is between 2 mm and 25 mm for the majority of the fibers of the fiber bundle, preferably between 5 mm and 12 mm.

7. Electrostatic precipitator according to claim 1, wherein the fibers of the fiber bundle have a diameter of 5 μm to 20 μm, preferably between 5 μm and 10 μm, and/or that the metal coating thickness is between 0.05 μm and 1.0 μm, preferably between 0.2 μm and 0.5 μm.

8. Electrostatic precipitator according to claim 1, wherein the fibers of the fiber bundle are metallically coated substantially along the fiber circumferential sides, at least in the spatial vicinity of the free front ends, wherein the front sides of the free front ends are preferably uncoated.

9. Electrostatic precipitator according to claim 1, wherein
the ioniser potential is at least 8 kV, preferably more than 10 kV, and most preferably more than 12 kV,
and/or that
the ionisation current per spray ionisation source is limited to less than 100 μA.

10. Spray ionization source for an electrostatic precipitator (10), wherein the spray ionization source is formed from a bundle of electrically conductive fibers with a metallic coating according to claim 1.
